(19) United States
(12) Patent Application Publication
(10) Pub. No.: US 2010/0116025 A1
(43) Pub. Date: May 13, 2010

(54) AIR SAMPLER

(75) Inventors: Paulo Gouveia, Everett, MA (US); Trine Nilsen, Moss (NO); Adrian Mark Thomas West, Newton, MA (US); John A. MacNeill, Acton, MA (US)

Correspondence Address: WOLF GREENFIELD & SACKS, P.C., 600 ATLANTIC AVENUE, BOSTON, MA, 02210-2206, US

(73) Assignee: U.S. GENOMICS, INC, Wobum, MA (US)

(21) Appl. No.: 12/311,377

(22) PCT Filed: Sep. 28, 2007
(86) PCT No.: PCT/US2007/020914

§ 371 Date: Jan. 15, 2010

Related U.S. Application Data
(60) Provisional application No. 60/847,821, filed on Sep. 28, 2006.

(51) Int. Cl. G01N 1/22

(52) U.S. Cl. 73/28.01; 73/863.22

(57) ABSTRACT

An air sampler includes an inertial impactor with a compressible porous collector that receives particles greater than a lower threshold size from an air sample. Before reaching the collector, the air sample may pass through a sorter that prevents that removes particles above an upper threshold size. A mechanism transfers the compressible porous collector and base between the air sampler and a wash position outside of the air sampler. An agitator at the wash position may agitate the compressible porous collector to remove particles therefrom. The compressor may be wetted with various substances to facilitate particle collection from the air, preservation of particles on the collector, and removal of particles from the collector.

### RELATED APPLICATIONS

This application claims priority under 35 U.S.C. §119(e) to U.S. Provisional Application Ser. No. 60/847,821 entitled “AIR SAMPLER,” filed on Sep. 28, 2006, which is hereby incorporated by reference in its entirety.

### FEDERALLY SPONSORED RESEARCH

This invention was made in part with government support under Contract Nos. W81XWH-04-9-0011 and HSHQPA-05-9-0019 from the Homeland Security Advanced Research Projects Agency. The Government may retain certain rights in the invention.

### BACKGROUND

In today's climate and heightened sensitivity to global terrorism, there exists a need for ways to detect weapons of bioterrorism such as chemicals and biologics, among other agents. In some approaches, this may be accomplished by monitoring the air for agents associated with such chemicals and biologics. It may prove beneficial for a detection system to be able to continuously monitor an area of interest, such as public places like airports, public transportation and office buildings. The effectiveness of such a monitoring system may relate to the ability of the detection system to operate continuously with minimal oversight.

### SUMMARY

According to one aspect of the invention, a method is disclosed for sampling airborne particles from air. The method comprises wetting a compressible porous collector of an inertial impactor, the compressible porous collector having an exposure face. The compressible porous collector is placed into an inertial impactor. Sample air that may contain particles is passed through the inertial impactor along a flow path such that particles over a threshold size will impact the exposure face of the compressible porous collector. The compressible porous collector is compressed to remove the particles contained therein.

Another aspect of the invention relates to a method of sampling particles from air that comprises wetting a compressible porous collector of an inertial impactor with a buffer solution, the compressible porous collector having an exposure face. Sample air, that may contain particles, is drawn through an air sampler along a flow path. The sample air is directed through a first sorter that prevents particles above an upper threshold size from continuing along the flow path in the air sample. The sample air is also directed through the inertial impactor such that particles of the sample air that are above a lower threshold size are directed onto the exposure face of the wetted compressible porous collector.

According to yet another aspect, a sample collector for an air sampler is disclosed. The sample collector comprises a base and a compressible porous collector mounted to the base and having an exposure face configured to receive particles from a flow path of an air sample passing through the air sampler. A transfer mechanism is configured to transfer the compressible porous collector and base between a particle collection position in the air sampler and a wash position outside of the air sampler. An agitator is positioned at the wash position and is configured to agitate the compressible porous collector to remove particles therefrom.

According to still another aspect, an air sampler is disclosed that comprises a pump configured to move sample air, that may contain particles, through the air sampler along a flow path. A first sorter in the flow path prevents particles above an upper threshold size in the sample air from continuing along the flow path in the air sample. A wetted compressible porous collector is configured to retain at least some of the particles of the air sample that are directed onto the wetted compressible porous collector. An inertial impactor in the flow path directs particles of the sample air that are above a lower threshold size onto the wetted compressible porous collector.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a cutaway perspective view of an air sampling system, according to one embodiment of the invention.

FIG. 2 shows a cross sectional view of an inertial impactor and the flow path of sample air through the impactor.

FIG. 3 shows one embodiment of a collector magazine that may be used in combination with the air sampler embodiment of FIG. 1.

FIGS. 4-7 show the air sampling system embodiment of FIG. 1, in various stages of operation. FIG. 4 shows a collection magazine that is being transferred from the air sampler and moved to the collection station. FIGS. 5 and 6, show an agitator in different stages of during a process of compressing a collector. FIG. 7 shows a basin of the collection station oriented to direct wash solution toward a sample tube.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items.

Aspects of the invention provide apparatuses, systems and methods for collecting and retaining airborne particles for subsequent analysis. The various aspects of the invention employ inertial impactors to collect airborne particles within a desired range of sizes. The airborne particles are collected on a wetted, porous, and/or compressible collector that is incorporated into an impact plate of the inertial impactor. Airborne particles are prevented from rebounding off of the collector, and are better retained therein due to the compressible, porous, and/or wetted characteristics of the collector. Subsequently, the collector is moved from the air sampler. Solution is applied to the collector and/or the collector is agitated to help remove any particles retained therein. The solution carries particles away from the collector and is then gathered for subsequent analysis. Additional aspects of the invention include wetting the collector with a buffer solution that is resistant to drying. Further aspects of the invention involve wetting the collector with a buffer solution that aids in the preservation of some biological particles that may be collected from the sample air.

According to some aspects of the invention, one or more porous, compressible collectors of an air sampler are mounted to a magazine that is configured to be readily transferred into and out of the air sampler. In this respect, the collector can be easily removed for any purpose, such as to extract particles from the collector, to apply solution to the collector and/or to replace the collector with a new collector or a collector of a different configuration.

According to some aspects, a sample collection station is configured to receive collectors from the air sampler for processing. The collection station can include fluid dispensers that apply various types of solution to the collectors. The collection station can also include a mechanism for agitating the collector to assist in removing particles retained therein.

According to additional aspects, the collection station may be configured to deliver particles removed from the collector to a point downstream for further processing and/or analysis. Some embodiments include a system that has a wash position, where wash solution is applied to remove particles from the collector, and a delivery position, where the wash solution is delivered downstream for subsequent processing and/or analysis.

According to some aspects, a porous collector is wetted with solutions that prevent the collector from drying out. High air flow rates associated with air samplers can create an environment where rapid evaporation of fluids is possible. Moreover, low relative humidity levels, like those typically found in buildings with heating and air conditioning systems, can promote even more rapid evaporation of fluids. Wetting the collector with an oil based substance, such as glycerol, can prevent the collector from drying out, even in the face of high flow rates at low relative humidity.

According to some aspects, the collector is wetted with a solution that promotes the preservation of biological particles received thereon. Some embodiments of air samplers are configured to collect particles that may include biological agents of interest, such as agents with DNA that is subsequently to be analyzed. Wetting the collector with a solution that contains nuclease inhibitors can promote retaining DNA intact on the collector, so as to improve the possibility of performing subsequent analysis on the DNA, including linear analysis of the DNA.

According to some aspects of the invention, the collector within the air sampler is made of compressible material to help promote the capture of airborne particles. In some embodiments, it is desirable for the collector to be somewhat elastic, such that the collector can give way, if even just slightly, when an airborne particle impacts the collector. A collector made of a compressible, relatively soft material can also help prevent damage to the particle upon impact with the collector.

According to some aspects of the invention, a porous collector is wetted with a fluid to help promote particle retention. The surface of the fluid on the porous collector can give way upon being impacted by the particle. Giving way, in this manner, can help dissipate the kinetic energy of the particle and thus reduce the likelihood of the particle rebounding back into the flow path or being damaged upon impact. In some instances, the particle may penetrate the surface of the fluid that wets the collector. In breaking the fluid surface, kinetic energy of the particle may be dissipated, further slowing the movement of the particle and thus further promoting particle retention in the collector. Additionally, once entrained within the fluid of the collector, rebound becomes less likely, as additional energy would be needed to again break the surface tension of the fluid and remove the particle therefrom.

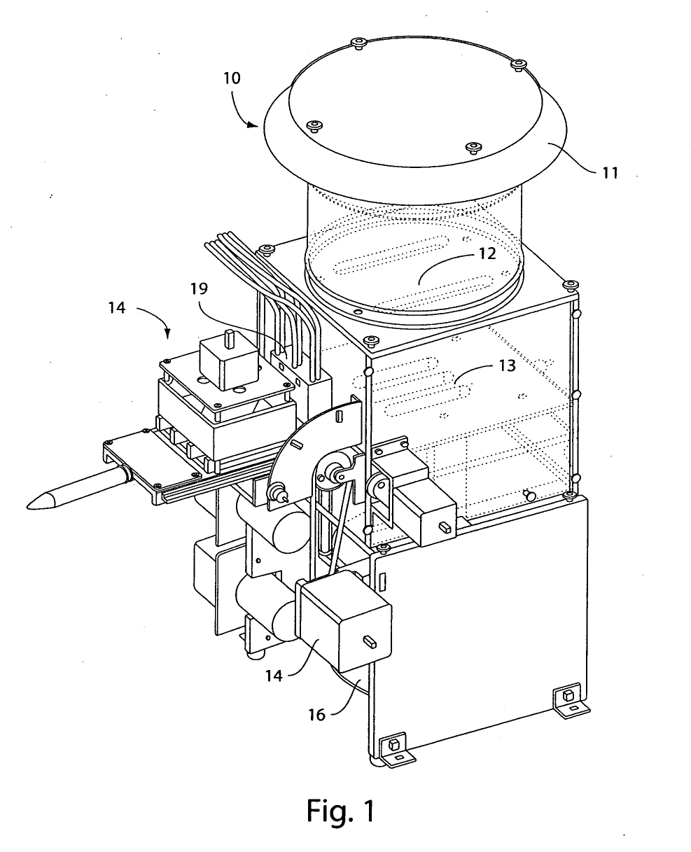

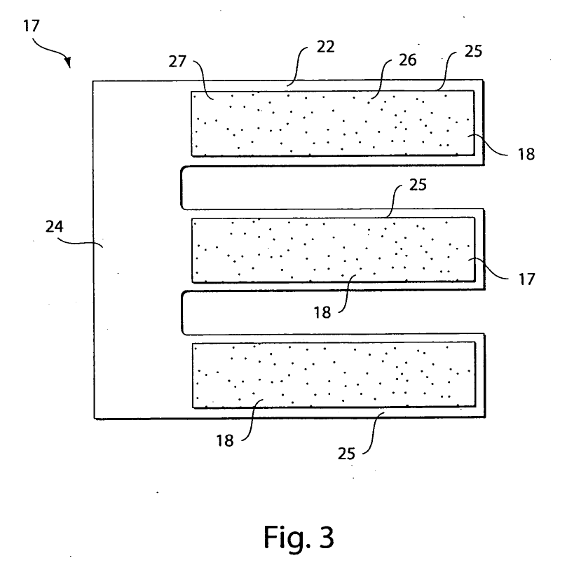

Turn now to the figures, and initially FIG. 1, which shows a cutaway perspective view of an air sampling system, according to one embodiment of the invention. The system includes an air sampler 10, an inlet housing 11, a first inertial impactor 12, a second inertial impactor 13, a collector magazine 17 (as shown in FIG. 3) positioned below the second inertial impactor, a collection station 14, a motor drive 15, and a blower 16.

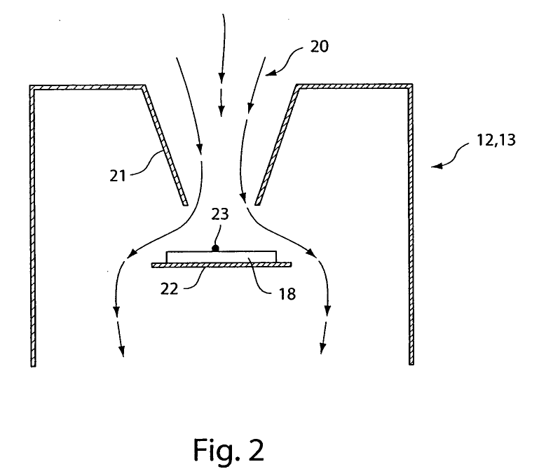

Broadly speaking, during air sampling in some embodiments, the blower 16 draws sample air into the inlet housing 11 of the air sampler 10. The sample air flows through the inlet housing 11 and then passes through the first inertial impactor 12. The first inertial impactor 12 is configured such that airborne particles above an upper threshold size of the overall air sampler are removed from the flow path of the air sample. The flow path then continues into the second inertial impactor 13, which is configured such that particles over a lower threshold size impact collectors 18 (as shown in FIGS. 2 and 3) that are arranged on the collector magazine 17 in the air sampler. Particles that are smaller than the lower threshold size continue along the flow path and exit the air sampler 10.

After a defined sampling interval, according to some embodiments, particles are removed from the collector 18 of the air sampler. Initially, the collector magazine 17 is transferred from the air sampler 10 and into the collection station 14. Fluid dispensers 19 within the collection station apply a wash solution to the collector 18, which helps remove any particles contained therein. The collectors are also agitated, such as by compression, to promote removal of the wash solution and particles from the collector. During the wash portion of the procedure, the collection magazine 17 is oriented in a wash position within the collection station 14. The wash solution is gathered in a basin that lies about the collector. Subsequently, the collection station rotates to a delivery position, where the collector may be agitated again. In the delivery position, wash solution is directed downstream, such as into a sample vial, for subsequent analysis. The collection station then returns to the wash position. Dispensers apply a buffer solution to the collector that includes both gylcerol and a nuclease inhibitor. Excess buffer solution may be removed from the collector by agitation. The collection magazine is then returned to the air sampler for an additional sampling interval.

FIG. 2 shows a cross sectional view of an inertial impactor, like either the first 12 or second 13 impactors of FIG. 1, and the flow path 20 of sample air through the impactor. The inertial impactor includes a nozzle 21 and an impact plate 22. A collector may be incorporated into the impact plate. Generally speaking, in an inertial impactor an air sample is directed through the nozzle 21 and toward the impact plate 22 and/or collector 18. The flow path of the air sample makes an abrupt change in direction due to the presence of the impact plate 22. The change in direction of the flow path causes particles 23 greater than a threshold size, which have too much inertia to follow the change in direction of the flow path 20, to exit the flow path and impact the plate. Particles 23 smaller than the threshold size continue along the flow path in the sample air.

As used herein, the term “threshold size”, refers to the particle size that will be removed from the flow path of sample air passing through an inertial impactor with an efficiency of 50%. Threshold size is typically quantified in terms of the “aerodynamic equivalent diameter” or “AED” of a particle. “AED”, as used herein refers to the diameter of a sphere of water having the same terminal settling velocity in still air as a given particle.

A more detailed description as to the operating mechanics of inertial impactors can be found in the publication “Sensor Systems for Biological Agent Attacks: Protecting Buildings and Military Bases”, National Research Council of the National Academies, National Academies Press, Washington, D.C. 2005 or “Basic Concepts in Environmental Sciences”, (http://www.epa.gov/eogaptil/module3/index.htm), each of which are hereby incorporated by reference in their entirety. Moreover, inertial impactors are commercially available through various sources.

In some illustrative embodiments of the invention a first sorter is used to remove particles from the flow path that are larger than an upper threshold size of the overall air sampler system prior to particles being collected from the air sample. By way of example, it has been determined that many biological warfare agents, when placed in aerosol, have an AED of between 1.0 and 10.0 microns. To prevent collection of particles that lie outside of this size range, some embodiments include a feature for removing particles that are greater than a threshold size of 10.0 microns.

In some embodiments, like that shown in FIG. 1, the first sorter is an inertial impactor 12 with a threshold size that is equal to the upper threshold size of the air sampler system. As illustrated, the first sorter comprises an inertial impactor with two nozzles and corresponding impact plates. The threshold size may be smaller than 0.1 microns, 1.0 microns, 10.0 microns, or 50.0 microns or greater, as there is no upper or lower bound on the threshold size that the first sorter may have. The inertial impactor 12 may include an impact plate that does not include a collector. In other embodiments, the impact plate may be coated with an oil based substance, such as grease or the like, to help retain particles therein. Still, in other embodiments, porous, compressible foam, either wet or dry, may be incorporated into the impact plate to help prevent particles from reentering the flow path after they have been removed therefrom. Although some embodiments may include an inertial impactor 12 as a first sorter, it is to be appreciated that other types of sorters may also be used, like filter elements, centrifuge filters, electrostatic filters, or no sorter at all, as aspects of the invention are not limited in this respect.

In the embodiment of FIG. 1, sample air passes from the first sorter to a housing that includes an inertial impactor 13 configured to collect particles that are above the lower threshold size of the overall air sampler system. Particles below the lower threshold size of the collector continue along the flow path beyond the second inertial impactor 13and eventually exit the air sampler 10.

The impact plate 22 and collectors 18 can be incorporated into a collector magazine 17 that facilitates moving the collectors 18 into and out of an air sampler 10. By way of example, FIG. 3 shows one embodiment of a collector magazine that may be used in combination with the air sampler embodiment of FIG. 1. The illustrated collector magazine is constructed of 0.10″ thick sheet metal cut into a pattern that defines a base 24 and three fingers 25 that extend from the base although other configurations are possible. The fingers act as impact plates, when positioned inside of an inertial impactor. A strip of open cell, polyurethane foam is mated to each finger and each strip serves as a collector, when in the inertial impactor. The base 24 provides a structure to connect each of the fingers 25, and to mount the collection magazine 17 to a transfer mechanism of the air sampler system.

The collector magazine 17 illustrated in FIG. 1 is configured for use in an inertial impactor that may process sample air at 800 Liters per minute with a threshold size of 1.0 microns, and with the collectors positioned within the air sampler for about 1 hour sample intervals. However, it is to be appreciated that other embodiments of collector magazines may be configured differently for use in air samplers with different operating parameters. By way of example, the number of fingers and corresponding collectors may be increased or decreased for an air sampler that processes a greater or lower volume of sample air, respectively. In some embodiments, the magazine may include only a single collector and corresponding impact plate such that there are no fingers on the magazine. In other embodiments, the length of the fingers may be extended or reduced to accommodate inertial impactors of different sizes. Other configurations that promote the transfer of collectors to and from the air sampler may be used, as the general layout and construction of the collector magazine are not limited to that shown in the embodiment of FIG. 3.

In some illustrative embodiments, the collector 17 may be porous to promote the retention of particles 23 within the collector. The increased retention associated with porous collectors may be due to various factors. For instance, a particle 23 that makes initial impact with a pore 26 of a collector 18 may be trapped therein, such that rebound away from the collector is prevented. In other instances, a particle may impact with a somewhat irregular portion of the collector surface near a pore. Such impact may cause the particle to rebound in a direction other than directly back into the flow path of the air sample, such that the particle may become subsequently trapped in a pore or passageway of the collector. Many porous collectors, like open cell foam collectors, provide labyrinth-like passageways through the collector. Air may flow through such passageways, helping to draw particles therein where the particles may become lodged. Polyurethane foam is one material that may be used to form a porous collector. However, it is to be appreciated that aspects of the invention are not limited in this regard, as other materials such as felt compositions, metal or glass flits, and the like may also be used to form a porous collector.

Some illustrative embodiments involve a porous collector 18 that is wetted with a fluid to help promote particle retention and/or preservation. By way of example, fluid that is present on a collector may provide for a softer impact between particles and the collector, so as to better dissipate some of the kinetic energy that might otherwise cause a particle to rebound away from the collector. Additionally, upon impact a particle may penetrate the surface of the fluid. The energy required to break the surface of the fluid may further slow the particle, making a rebound away from the collector less likely. Moreover, additional energy is required to break the fluid surface if a particle is to exit the fluid, which further promotes retention of the particles in fluid. Various fluids may be used to wet porous collectors, such as water, glycerol, and the like, as aspects of the invention are not limited to any one fluid.

In some illustrative embodiments, the fluid may include constituents that prevent evaporation of fluid from the collector 18. By way of example, in some embodiments the fluid includes components with stronger intermolecular bonds than are typically found in water. These stronger bonds may reduce the evaporation rate of a fluid, all else constant. In one embodiment, the buffer solution includes glycerol which can prevent the evaporation of water and other fluids with which it is mixed. In another embodiment, the buffer solution comprises a mixture of water with the following additives: 0.01% Tween-80 (by volume), 50 mM EDTA pH 8, and 30% glycerol (by volume). As used herein, the term “buffer solution”, refers to the solution that is resident on a collector when positioned in the air sampler for particle collection. In some embodiments, the buffer solution includes 30% glycerol. In other embodiments, less glycerol, such as 20%, 10%, or even lower percentages, are included in the buffer solutions. Still, in other embodiments, greater percentages of glycerol are included in the buffer solution, such as 50%, 75%, or even 100%, as aspects of the invention are not limited in this respect.

Collectors may also be wetted with solutions that can promote the preservation of certain particles that are received on the collector, such as biological agents. As discussed herein, some embodiments of air samplers are configured to capture biological agents that may be present as particles in an air sample. Some of such biological agents may be damaged after prolonged periods of exposure to an environment with salt levels that are either too high or too low. In such environments, osmosis that occurs across the cell wall may lead to cell damage and/or digestion and/or cleaving of the DNA inside of the cell. To help retain DNA intact, the buffer solution may include a nuclease inhibitor to prevent digestion and/or cleaving of DNA. In one embodiment, the buffer solution includes ethylenediaminetetraacetic acid (EDTA) as a nuclease inhibitor, although other nuclease inhibitors may also be used, as aspects of the invention are not limited in this respect.

The preservation of biological agents on the collector may also be promoted by keeping the collector in a wetted state. To this extent, glycerol and other like constituents may further aid in the preservation of biological agents, including DNA, once received on the collector.

In some illustrative embodiments, the collector comprises a porous, compressible material that helps prevent damage to particles received thereon. A compressible collector may be capable providing a softer impact when an airborne particle contacts the collector. This can help prevent the particle from bouncing off of the collector and reentering the flow path of the sample air and may also prevent a particle from being damaged upon impact with the collector.

In some illustrative embodiments, collectors are formed from a material that is compressible, porous, and capable of retaining a buffer solution. By way of example, the embodiment illustrated in FIG. 3 includes strips 27 of open cell polyurethane foam that are capable of retaining buffer solution during air sampling. Specifically, the embodiment of FIGS. 1 and 3 includes three strips of polyurethane foam each with a length of 3.75 inches, a width of 0.2 inches, and a thickness of 0.125 inches, although other embodiments may include collectors of different dimensions. The foam is mated to the impact plate 22 of the collector magazine 17 with adhesive, but other fasteners may also be used. In one embodiment the polyurethane foam is reticulated polyurethane foam with a porosity of 100 pores per inch and a density of 1.9 pounds per cubic foot, but larger or smaller porosities and densities are possible, as aspects of the invention are not limited in this regard. Such polyurethane foam may be acquired from Foamex International Inc. of Linnwood, Pa., among other commercial sources.

Illustrative embodiments of the present invention may be configured for automated operation. Such embodiments may have a sampling mode, where sample air is passed through the system and particles are collected, and a wash mode, where particles are removed from the collector in preparation for subsequent analysis. Typically, the sampling mode continues for a standard sample interval, during which sample air is drawn through the system and particles are collected, although the intervals may also be variable. Sample intervals may be of different durations, and in some embodiments may be for as long as 10 minutes, 30 minutes, 1 hour, 2 hours, or for any other durations, as aspects of the invention are not limited in this respect.

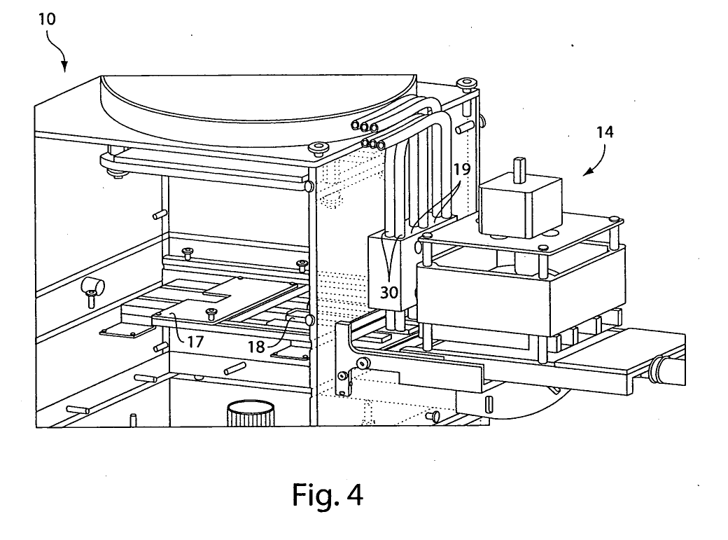

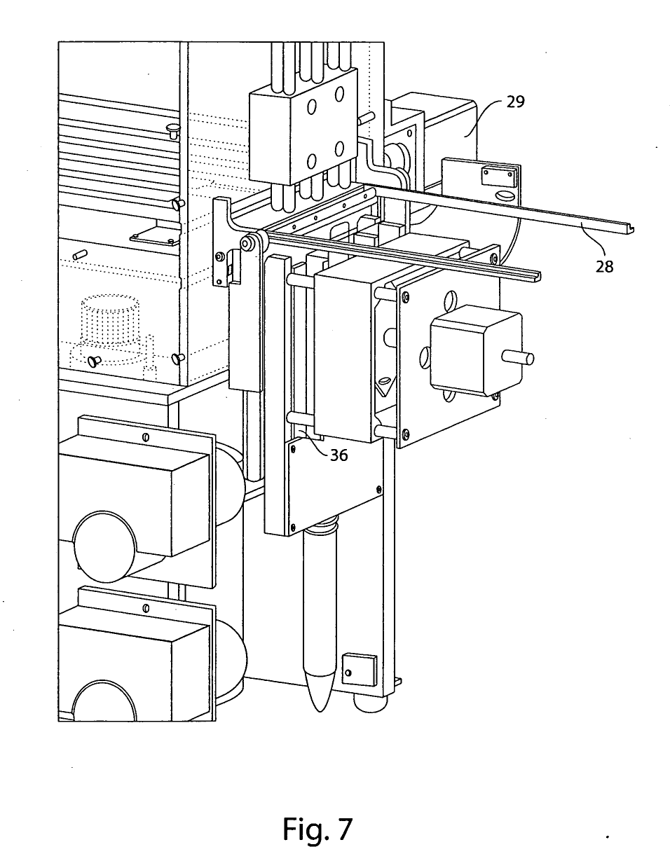

In the illustrative embodiment of FIG. 1, the wash mode begins at the end of the sample interval as the blower of the system is turned off. However, in some embodiments, the blower may continue to run during the wash mode. The collection magazine is subsequently transferred from the air sampler and moved to the collection station, as is shown occurring in FIG. 4. To facilitate this transfer, the embodiment shown in FIG. 4 includes a rack 28 (see FIG. 7) that is mated to the collection magazine 17. A motor 29 drives a pinion gear in the transfer station engages the rack 28, and upon being actuated, moves the rack 28 and the collection magazine 17 from the air sampler 10 and into the collection station 14. It is to be appreciated that other mechanisms may also be used to transfer the collection magazine to/from the air sampler and into collection station, as aspects of the invention are not limited to the above described rack and pinion arrangement.

Fluid dispensers 19 may be incorporated into the system to apply various solutions to the collectors. By way of example, as shown in the embodiment of FIG. 4, a pair of nozzles 30 are positioned above the pathway that each collector 18 follows when transferred between the air sampler 10 and the collection station 14. A first of each of the pair of nozzles 30 is configured to dispense a wash solution to the collectors as the collectors are transferred to the collection station. A second of each of the pair of nozzles 30 is configured to apply a buffer solution to the collectors either while or before they are returned to the air sampler to collect particles. Each dispenser may be connected to a peristaltic pump that drives the corresponding fluid through the nozzle of the dispenser and onto the collector, although other mechanisms for pumping fluid and other configurations are possible as aspects of the invention are not limited in this respect.

As mentioned herein, in some embodiments a wash solution is used to promote removal of particles that may be resident on the collector. As used herein, the term “wash solution” refers to any solution applied to a collector to remove particles contained therein. Wash solutions may contain various different constituents, however, many include a detergent to help reduce the surface tension of buffer solutions that may be resident on the collector, such that the buffer solution and any particles contained therein may more readily be removed from the collector. The wash solution may also include constituents that help preserve particles, such as biological agents including DNA. In some embodiments, such constituents include nuclease inhibitors like EDTA, although other constituents are possible, as aspects of the invention are not limited in this respect. In one embodiment, the wash solution comprises water with the following additives: 0.01% Tween-80 (by volume), 50 mM EDTA pH 8, and 5 mM Tris.

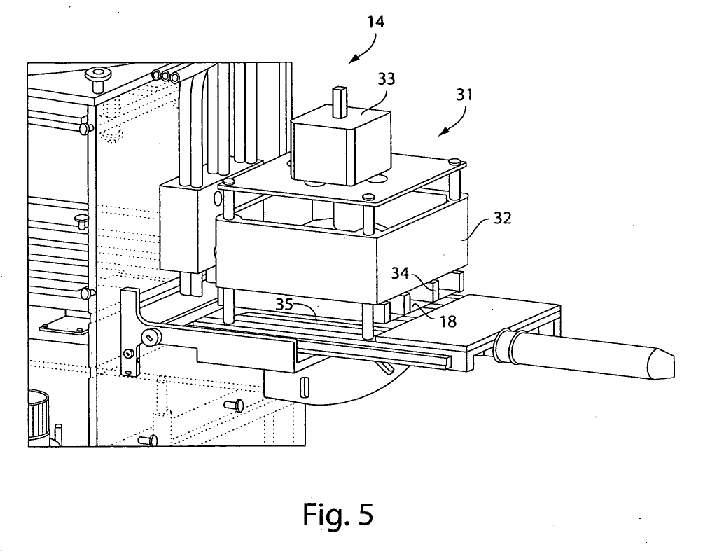

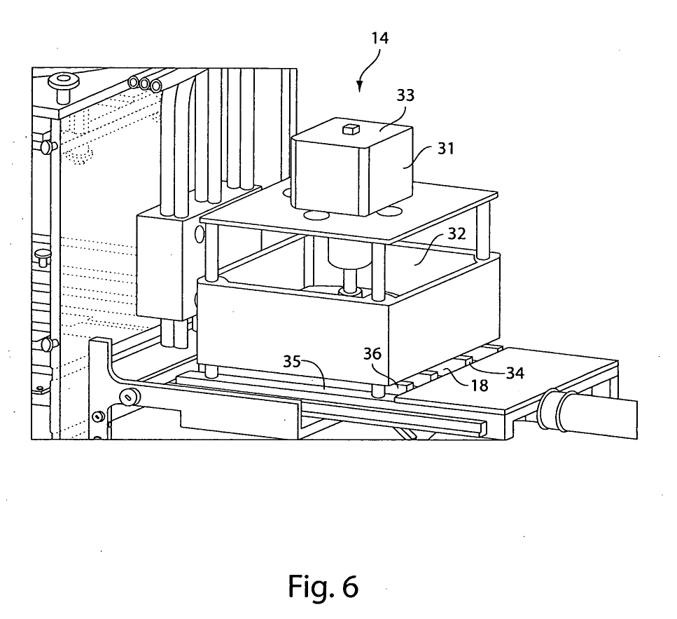

Illustrative embodiments of collection stations may include an agitator 31 to help remove wash solution and particles from the collector 18. As shown in FIGS. 5 and 6, the agitator 31 can include a press 32 configured to compress a compressible collector 18 one or more times, thereby removing wash solution and particles therefrom. As illustrated, the press includes a linear actuator 33, a press surface 34, and platen 35 that is opposed from the press surface. The collector(s) 18, when transferred to the collection station 14, is placed between the press surface 34 and the platen 35. Subsequently, the linear actuator moves the press surface toward the platen and agitates (e.g., compresses) the collector there between, as is shown in FIG. 6.

Compressing the collector drives wash solution, and any particles contained therein, out of the pores of the collector and into a collection basin 36 that lies about the collector 18. Compressing the entire collector at once has been found to effectively remove particles therefrom. By way of example, in some embodiments, the press contacts the entire exposure face of the collector (i.e., the face of the collector that receives particles when positioned in an inertial impactor) at a common time. In some embodiments, the platen and/or press surface may include apertures of a textured surface to provide passageways for fluid removed from the collector. In one such embodiment, the press surface comprises a stainless steel sheet that is 0.018 inches thick. The sheet is perforated in an area corresponding to each foam collector with a grid of 0.080 inch square holes arranged on a 0.1 inch pitch. In the illustrative embodiment, three perforated areas each measure 0.58 inches by 3.78 inches, and are each positioned to be centered above a corresponding collector when in the collection station. However, in other embodiments, the press surface and platen may comprise a solid surface as aspects of the present invention are not limited in this regard. Other approaches to agitating the collector to remove wash solution and particles are also possible. By way of example, a roller may be rolled across the collector to compress the collector, the collector may be immersed in and agitated back in forth within a wash solution, the collector may be centrifuged to remove wash solution, and the like, as aspects of the invention not limited in this respect.

The press 32 shown in FIGS. 5 and 6, or any other agitation devices, may repeatedly compress the collector to remove wash solution. Moreover, dispensers may apply additional wash solution to the collector, for further agitating before the wash mode is ended and the collector is returned to the air sampler.

According to one illustrative embodiment, the collector magazine 17 is transferred from the air sampler 10 and moved to the collection station 14. As the collectors pass beneath the dispensers 19, 1.25 mL of wash solution is applied by each dispenser 19 to a corresponding collector 81. Subsequently, each collector 18 is agitated (e.g., compressed by the press,) forty times. The basin 36 of the collection station is then rotated, with the collectors 18 in the fully compressed state, such that the collector magazine 17 and collectors 18 lie along a substantially vertical plane. As discussed herein, such an orientation may promote gathering of the solution and particles for subsequent analysis. While oriented along the vertical plane, the collectors 18 may be released by the press, and agitated again, such as by being compressed 15 times. During this portion of the procedure, typically between 0.6 to 1.0 mL of wash solution are recovered from the collectors 18. The collector magazine 17 and collectors 18 may then be returned to the horizontal position and passed beneath the dispensers 19 where an additional 1.25 mL of wash solution is applied to each collector 18. The process may then be repeated with the collectors 18 agitated 40 times in the horizontal position and 15 times in a vertical position. Repeating the process a second time, in this manner, typically recovers between 1.1 and 1.2 mL of wash solution. Repeating the procedure a third time, in the same manner, typically produces a sum total amount of liquid recovered that is typically between 3.0 and 3.4 mL.

Embodiments of the collection station may include features to gather the wash solution for subsequent analysis. As mentioned above, wash solution and particles may be gathered in a basin 36 of the collection station and then delivered downstream for subsequent processing. In the embodiment of FIG. 1, as shown in greater detail in FIG. 7, the basin of the collection station may be rotated by a motor to an inclined position such that wash solution will be directed to a lower portion of the basin. The embodiment of FIG. 7 includes a sample tube that receives solution from the basin when in the inclined position. The sample tube has an outlet that can deliver the solution downstream for sample preparation and/or analysis. Although FIG. 7 shows one manner in which solution can be gathered for delivery, it is to be appreciated that other arrangements are possible, as the present invention is not limited to the embodiment shown in FIG. 7.

In the illustrated embodiment, the agitator 32 also rotates with the basin 36. This configuration allows the agitator to be actuated while the basin is located on an incline, to further promote the purging of any wash solution that may be remaining in the collectors.

After collecting particles from the collector 18, the collector may be prepared for return to the air sampler 10 so that the system may be returned to the sampling mode. This may include reapplying buffer solution to the collector 18. To accomplish this, according to one embodiment of the invention, the collector magazine 17 is passed beneath the dispenser 19, which dispenses an appropriate amount of buffer solution. In some embodiments, the collector may be positioned beneath the agitator and the agitator actuated one or more times such that excess buffer solution is removed from the collector. Subsequently, the collector is transferred to the air sampler 10, the blower 16 is actuated, and the next sampling interval begins.

According to one illustrative embodiment, the collector is prepared for return to the air sampler 10 by twice passing each of the collectors 18 beneath a corresponding dispenser 19. During each pass beneath the dispenser 19, 1.25 mL of buffer solution are applied onto each collector 18. Subsequent to each pass beneath the dispenser 19, the collectors are transferred to the collection station 14, where each collector is compressed 10 times by the press 32. Excess buffer solution is drained away by placing the collection station 14 about the vertical plane, where the collectors 18 are each compressed again, 7 times, while remaining vertical. After this procedure, residue remaining in the foam is approximately 0.6 mL.

Air samples can be collected from virtually any source known or suspected to contain a particle of interest. They may be purified but usually are not. Different samples can be collected from different environments in the same manner by using the appropriate air sampler.

The invention further contemplates collection of particles that may be biowarfare targets. Air, liquids and solids that will come into contact with the greatest number of people are most likely to be biowarfare targets. Samples to be tested for the presence of such agents may be taken from an indoor or outdoor environment. Such biowarfare sampling can occur continuously, although this may not be necessary in every application. For example, in an airport setting, it may only be necessary to harvest randomly a sample near or around select areas, such as baggage claim areas. In other instances, it may be necessary to continually monitor (and thus sample the environment). These instances may occur in “heightened alert” states.

Air samples can be tested for the presence of normally airborne particles as well as aerosolized (or weaponized) chemicals or biologics that are not normally airborne.

Air samples can be taken from a variety of places suspected of being biowarfare targets including public places such as airports, hotels, office buildings, government facilities, and public transportation vehicles such as buses, trains, airplanes, and the like.

The invention is not limited in the nature of the particle being collected. These particles may include, but are not limited to agents like cells and cell components (e.g., proteins and nucleic acids), chemicals and the like. These agents may be biohazardous agents as described in greater detail herein. Target agents may be naturally occurring or non-naturally occurring, and this includes agents synthesized ex vivo but released into a natural environment. As described herein, the methods and systems of the invention can be used to modify one or more agents concurrently, simultaneously or consecutively. A plurality of agents is more than one and less than an infinite number. It includes less than 10¹⁰, less than 10⁹, less than 10⁸, less than 10⁹, less than 10⁷, less than 10⁶, less than 10⁵, less than 10⁴, less than 5000, less than 1000, less than 500, less 100, less than 50, less than 25, less than 10 and less than 5, as well as every integer therebetween as if explicitly recited herein.

The invention can be applied to the collection, detection and/or optionally identification and/or quantification of any particle, but most preferably rare agents which would otherwise be costly to detect. One example of such agents is biohazardous or biowarfare agents. These agents can be biological or chemical in nature. Biological biowarfare agents can be classified broadly as pathogens (including spores thereof) or toxins. As used herein, a pathogen (including a spore thereof) is an agent capable of entering a subject such as a human and infecting that subject. Examples of pathogens include infectious agents such as bacteria, viruses, fungi, parasites, mycobacteria and the like. Prions may also be considered pathogens to the extent they are thought to be the transmitting agent for CJD and like diseases. As used herein, a toxin is a pathogen-derived agent that causes disease and often death in a subject without also causing an infection. It derives from pathogens and so may be harvested therefrom. Alternatively, it may be synthesized apart from pathogen sources. Biologicals may be weaponized (i.e., aerosolized) for maximum spread.

CDC Category A agents include Bacillus anthracis (otherwise known as anthrax), Clostridium botulinum and its toxin (causative agent for botulism), Yersinia pestis (causative agent for the plague), variola major (causative agent for small pox), Francisella tularensis (causative agent for tularemia), and viral hemorrhagic fever causing agents such as filoviruses Ebola and Marburg and arenaviruses such as Lassa, Machupo and Junin.

CDC Category B agents include Brucellosis (Brucella species), epsilon toxin of Clostridium perfringens, food safety threats such as Salmonella species, E. coli and Shigella, Glanders (Burkholderia mallei), Melioidosis (Burkholderia pseudomallei), Psittacosis (Chlamydia psittaci), Q fever (Coxiella burnetii), ricin toxin (from Ricinus communis—castor beans), Staphylococcal enterotoxin B, Typhus fever (Rickettsia prowazekii), viral encephalitis (alphaviruses, e.g., Venezuelan equine encephalitis, eastern equine encephalitis, western equine encephalitis), and water safety threats such as e.g., Vibrio cholerae, Cryptosporidium parvum.

CDC Category C agents include emerging infectious diseases such as Nipah virus and hantavirus.

Further examples of bacteria that can be used as biohazards include Gonorrhea, Staphylococcus spp., Streptococcus spp. such as Streptococcus pneumoniae, Syphilis, Pseudomonas spp., Clostridium difficile, Legionella spp., Pneumococcus spp., Haemophilus spp. (e.g., Haemophilus influenzae), Klebsiella spp., Enterobacter spp., Citrobacter spp., Neisseria spp. (e.g., N. meningitidis, N. gonorrhoeae), Shigella spp., Salmonella spp., Listeria spp. (e.g., L. monocytogenes), Pasteurella spp. (e.g., Pasteurella multocida), Streptobacillus spp., Spirillum spp., Treponema spp. (e.g., Treponema pallidum), Actinomyces spp. (e.g., Actinomyces israelli), Borrelia spp., Corynebacterium spp., Nocardia spp., Gardnerella spp. (e.g., Gardnerella vaginalis), Campylobacter spp., Spirochaeta spp., Proteus spp., and Bacteriodes spp.

Further examples of viruses that can be used as biohazards include Hepatitis virus A, B and C, West Nile virus, poliovirus, rhinovirus, HIV, Herpes simplex virus 1 and 2 (including encephalitis, neonatal and genital forms), human papilloma virus, cytomegalovirus, Epstein Barr virus, Hepatitis virus A, B and C, rotavirus, adenovirus, influenza virus including influenza A virus, respiratory syncytial virus, varicella-zoster virus, small pox, monkey pox and SARS virus.

Further examples of fungi that can be used as biohazards include candidiasis, ringworm, histoplasmosis, blastomycosis, paracoccidioidomycosis, crytococcosis, aspergillosis, chromomycosis, mycetoma, pseudallescheriasis, and tinea versicolor.

Further examples of parasites that can be used as biohazards include both protozoa and nematodes such as amebiasis, Trypanosoma cruzi, Fascioliasis (e.g., Facioloa hepatica), Leishmaniasis, Plasmodium (e.g., P. falciparum, P. knowlesi, P. malariae,) Onchocerciasis, Paragonimiasis, Trypanosoma brucei, Pneumocystis (e.g., Pneumocystis carinii), Trichomonas vaginalis, Taenia, Hymenolepsis (e.g., Hymenolepsis nana), Echinococcus, Schistosomiasis (e.g., Schistosoma mansoni), neurocysticercosis, Necator americanus, and Trichuris trichuria, Giardia.

Further examples of mycobacteria that can be used as biohazards include M. tuberculosis or M. leprae.

Examples of toxins include abrin, ricin and strychnine. Further examples of toxins include toxins produced by Corynebacterium diphtheriae (diphtheria), Bordetella pertussis (whooping cough), Vibrio cholerae (cholera), Bacillus anthracis (anthrax), Clostridium botulinum (botulism), Clostridium tetani (tetanus), and enterohemorrhagic Escherichia coli (bloody diarrhea and hemolytic uremic syndrome), Staphylococcus aureus alpha toxin, Shiga toxin (ST), cytotoxic necrotizing factor type 1 (CNF1), E. coli heat-stable toxin (ST), botulinum, tetanus neurotoxins, S. aureus toxic shock syndrome toxin (TSST), Aeromonas hydrophila aerolysin, Clostridium perfringens perfringolysin O, E. coli hemolysin, Listeria monocytogenes listeriolysin O, Streptococcus pneumoniae pneumolysin, Streptococcus pyogenes streptolysine O, Pseudomonas aeruginosa exotoxin A, E. coli DNF, E. coli LT, E.coli CLDT, E. coli EAST, Bacillus anthracis edema factor, Bordetella pertussis dermonecrotic toxin, Clostridium botulinum C2 toxin, C. botulinum C3 toxin, Clostridium difficile toxin A, and C. difficile toxin B.

In important embodiments, particles may be collected for the subsequent analysis of nucleic acids therein, particularly where the nucleic acid is DNA or RNA. DNA includes genomic DNA (such as nuclear DNA and mitochondrial DNA), as well as in some instances complementary DNA (cDNA). RNA includes messenger RNA (mRNA), miRNA, and the like. The nucleic acid may be naturally or non-naturally occurring. Non-naturally occurring nucleic acids include but are not limited to bacterial artificial chromosomes (BACs) and yeast artificial chromosomes (YACs). Harvest and isolation of nucleic acids are routinely performed in the art and suitable methods can be found in standard molecular biology textbooks. (See, for example, Maniatis' Handbook of Molecular Biology.)

The nucleic acids may be double-stranded, although in some embodiments the nucleic acid targets are denatured and presented in a single-stranded form. This can be accomplished by modulating the environment of a double-stranded nucleic acid including singly or in combination increasing temperature, decreasing salt concentration, and the like. Methods of denaturing nucleic acids are known in the art.

The target nucleic acids commonly have a phosphodiester backbone because this backbone is most common in vivo. However, they are not so limited. Backbone modifications are known in the art. One of ordinary skill in the art is capable of preparing such nucleic acids without undue experimentation. The probes, if nucleic acid in nature, can also have backbone modifications such as those described herein.

Thus the nucleic acids may be heterogeneous in backbone composition thereby containing any possible combination of nucleic acid units linked together such as peptide nucleic acids (which have amino acid linkages with nucleic acid bases, and which are discussed in greater detail herein). In some embodiments, the nucleic acids are homogeneous in backbone composition.

An example of a suitable system for performing subsequent linear analysis on DNA collected from particles is the GeneEngine™ (U.S. Genomics, Inc., Woburn, Mass.). The Gene Engine™ system is described in PCT patent applications WO98/35012 and WO00/09757, published on Aug. 13, 1998, and Feb. 24, 2000, respectively, and in issued U.S. Pat. No. 6,355,420 B1, issued Mar. 12, 2002. The contents of these applications and patent, as well as those of other applications and patents, and references cited herein are incorporated by reference herein in their entirety. This system is both a single molecule analysis system and a linear polymer analysis system. It allows, for example, single nucleic acids to be passed through an interaction station in a linear manner, whereby the nucleotides in the nucleic acid are interrogated in order to determine whether there is a detectable label conjugated to the nucleic acid. Interrogation involves exposing the nucleic acid to an energy source such as optical radiation of a set wavelength. The mechanism for signal emission and detection will depend on the type of label sought to be detected, as described herein.

### Equivalents

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the invention. The advantages and objects of the invention are not necessarily encompassed by each embodiment of the invention.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of sampling airborne particles from air, the method comprising:
wetting a compressible porous collector of an inertial impactor, the compressible porous collector having an exposure face;
placing the compressible porous collector into an inertial impactor;
passing sample air that may contain particles through the inertial impactor along a flow path such that particles over a threshold size will impacts the exposure face of the compressible porous collector;
compressing the compressible porous collector to remove the particles contained therein.

2. The method of claim 1, wherein compressible collector is removed from the inertial impactor prior to being compressed.

3. The method of claim 1, wherein compressing the compressible collector comprises compressing the entire exposure face of the porous compressible collector.

4. The method of claim 1, wherein compressing the compressible porous collector comprises:
rewetting the compressible porous collector; and then
recompressing the compressible porous collector to remove particles contained therein.

5. The method of claim 4, further comprising:
repeating the steps of rewetting and recompressing multiple times.

6. The method of claim 4, wherein rewetting is performed with an wash solution that includes a nuclease inhibitor.

7. The method of claim 4, wherein rewetting is performed with a wash solution that includes a detergent.

8. The method of claim 1, wherein wetting comprises wetting the compressible porous collector with a buffer solution that resists evaporating in the inertial impactor.

9. The method of claim 1, further comprising:
rewetting the compressible collector with a buffer solution that resists evaporating, after the compressible collector has been compressed to remove particles.

10. The method of claim 8, wherein the buffer solution includes a nuclease inhibitor.

11. The method of claim 8, wherein the buffer solution includes glycerol.

12. The method of claim 1, further comprising:
gathering particles removed from the compressible porous in a basin; and
orienting the basin on an incline to deliver the particles collected to a collector to drain and collect solution removed therefrom.

13. The method of claim 1, wherein wetting the compressible porous collector comprises
applying wash solution to the compressible porous collector as the compressible porous collector is passed beneath a dispenser.

14. A method of sampling particles from air, the method comprising:
wetting a compressible porous collector of an inertial impactor with a buffer solution, the compressible porous collector having an exposure face;
drawing sample air, that may contain particles, through an air sampler along a flow path;
directing the sample air through a first sorter that prevents particles above an upper threshold size from continuing along the flow path in the air sample; and
directing the sample air through the inertial impactor such that particles of the sample air that are above a lower threshold size are directed onto the exposure face of the wetted compressible porous collector.

15. The method of claim 14, wherein the upper threshold size is an aerodynamic diameter of 10 microns.

16. The method of claim 15, wherein the lower threshold size is an aerodynamic diameter of 1 micron.

17. The method of claim 14, further comprising:
applying a wash solution to the compressible porous collector; and
compressing the compressible porous collector, when removed from the flow path, to remove particles contained therein.

18. The method of claim 17, wherein compressing the compressible collector comprises compressing the entire exposure face of the porous compressible collector.

19-25. (canceled)

26. A sample collector for an air sampler, the sample collector comprising:
a base;
a compressible porous collector mounted to the base and having an exposure face configured to receive particles from a flow path of an air sample passing through the air sampler;
a transfer mechanism configured to transfer the compressible porous collector and base between a particle collection position in the air sampler and an wash position outside of the air sampler; and
an agitator positioned at the wash position and configured to agitate the compressible porous collector to remove particles therefrom.

27-39. (canceled)

40. An air sampler comprising:
a pump configured to move sample air, that may contain particles, through the air sampler along a flow path;
a first sorter in the flow path that prevents particles above an upper threshold size in the sample air from continuing along the flow path in the air sample;
a wetted compressible porous collector configured to retain at least some of the particles of the air sample that are directed onto the wetted compressible porous collector; and
an inertial impactor in the flow path that directs particles of the sample air that are above a lower threshold size onto the wetted compressible porous collector.

41-56. (canceled)
